(19) United States
(12) Patent Application Publication
(10) Pub. No.: US 2003/0132914 A1
(43) Pub. Date: Jul. 17, 2003

(54) Integrated computer mouse and pad pointing device

(76) Inventor: Calvin Chunliang Lee, Novi, MI (US)

Correspondence Address: Calvin Chunliang Lee, 24294 Lynwood Dr., Novi, MI, 48374, US

(21) Appl. No.: 10/051,503

(22) Filed: Jan. 17, 2002

(51) Int. Cl. G09G 5/08

(52) U.S. Cl. 345/163

(57) ABSTRACT

An integrated mouse and pad pointing device is thin and compact that can be built into a laptop computer or other portable computational devices such as a personal data assistant (PDA) or a cell phone with a cursor to replace the cursor control devices such as the touch pad or the pointing stick. This integrated mouse and pad pointing device has a mouse sliding in a slot of a pad plate while the pad plate slides relative to or rotates about a stationary base plate. By sensing the movement of the mouse in the slot relative to the pad plate and the movement of the pad plate relative to the stationary base plate, the movement of the mouse and hence the cursor is determined. This mouse works like a conventional mouse so it is ergonomically easy and accurate to use to control the movement of the cursor. This integrated mouse and pad pointing device with the built-in click buttons in a portable computational device such as a laptop computer allows a convenient operation of controlling the cursor movement and the clicking of the buttons at the same time. A stand-alone version of this device may be plugged in to a desktop computer and will work on any condition.

### BACKGROUND

1. Field of Invention

A computer mouse is a cursor pointing device that a computational device such as a computer or a personal data assistant (PDA) user uses to control the movement of the cursor on the screen of the display. A mouse is usually used with a mouse pad which provides a smooth and flat surface for the mouse to slide on.

There are other cursor movement control devices such as the arrow keys on the keyboard, the touch pad, and the miniature joystick-type pointing stick. The arrow keys, which can be found in some PDA's, are not really an alternative to the mouse because they don't provide full control of the cursor movement. The touch pad and the miniature pointing stick are usually found in the portable computational applications such as a laptop computer or a PDA due to their compactness.

This invention is about a cursor movement control device with the mouse built into the mouse pad as one compact unit. It may also have the click buttons integrated into the unit. This integrated mouse and pad pointing device is to replace the conventional mouse for the desktop computational applications and the touch pad or the miniature pointing stick for the portable computational applications.

2. Description of Prior Art

A conventional computer mouse has a motion detection mechanism built into the mouse that works on a flat and smooth surface such as a mouse pad or a desktop. The motion detection mechanism can either be a roller ball with a pair of wheel-type position sensors inside the mouse for a “mechanical mouse” or an optical position sensor for an “optical mouse”.

A critical requirement for a conventional mouse to function properly is that it needs a flat and smooth surface like a desktop or, more preferably, a mouse pad to slide on. Without the provision of such a surface a conventional mouse may not function properly. To experience the importance of a flat and smooth surface to the operation of a conventional mouse is just use the mouse on a carpet then you will know how difficult it is to move the cursor to where you want it to be.

However, if a conventional mouse is fitted with an appropriate pad or a smooth surface, it functions very well.

A conventional mouse, either of the roller ball/mechanical type or the optical type, is usually too large to fit into a portable computational device such as a laptop computer, a PDA, or a cell phone.

A touch pad is usually found in a computational device such as a laptop computer. It is a pressure-sensitive device that, when pressed by an object such as a finger or a stylus, senses the movement of the contact point of the object on the pad and sends a signal to tell the computational device where the cursor should be moved to on the screen of the display.

A miniature joystick-type pointing stick, sometimes also called “track point,” is also found in some computational devices. The pointing stick functions like a miniature joystick that when it is pushed to one direction the cursor moves accordingly.

One of the major problems with the touch pad or the pointing stick is that it is difficult to use to accurately control the cursor movement. Just try to use the touch pad or the pointing stick in a laptop computer to accurately move the cursor to a certain location on the screen and you will realize it is not as easy to use as a conventional mouse.

Another problem is that the touch pad or the pointing stick has no built-in click buttons like a conventional mouse that can be conveniently clicked while the user moves the mouse. Usually the user needs to use one hand to move the cursor while awkwardly using either another finger of the same hand or a finger of the other hand to press the click buttons.

There are some other types of computer pointing devices such as the mouse with a roller ball on top so there is no need to slide the mouse itself to move the cursor. By rolling the ball with fingers the user can control the cursor movement. It is not as easy to use to control the cursor movement by rolling the ball as by sliding a conventional mouse. Besides, this type of mouse is usually for the desktop applications because the size of the ball has to be reasonably large to be user friendly.

Another type of computer pointing devices has a scroll wheel on the top. The scroll wheel provides an alternate means to control the cursor in the vertical direction. Similar to the roller ball mouse, it is not as easy to use to control the cursor movement by rolling the scroll wheel as sliding a conventional mouse. The diameter of the wheel also needs to be reasonably large to use and that is a limiting factor for a miniaturization of the pointing device.

One type of computer pointing devices of prior art [U.S. Pat. Nos. 6,034,670, 6,282,798, and 6,323,844], which integrates into a keyboard, uses a sliding X-Y table type of mechanism to detect the movement of the upper half of the device, which is the mouse, relative to the lower half of the device, which is stationary and fixed to the keyboard. However, this design has a critical problem: the mouse needs to be wide and long enough to cover the internal parts, including the X-Y table mechanism, so they will not be exposed to the outside. This is a serious problem for the portable computational applications where the availability of top surface space is very limited. Due to its complicated mechanism inside, this type of pointing devices is expensive to manufacture.

A similar type of the computer pointing devices of prior art [U.S. Pat. No. 5,488,392] moves the mouse of the sliding X-Y table type pointing devices from the keyboard to the front or sides of the keyboard while keeping the lower half of the pointing device inside the keyboard. It has a supporting structure, such as a pair of cantilever beams, connects the mouse to the internal movement detection mechanism in the lower half of the pointing device. This arrangement solves the keyboard's top surface space availability problem but the sticking out mouse is prone to break and lacks the necessary vertical support that may cause operational difficulties. It also needs a retractable mechanism for the mouse to slide out from and back into the keyboard and that makes this design complicated and expensive.

Another type of computer pointing devices of prior art [U.S. Pat. Nos. 6,307,535 and 6,337,680 and WO 9,947,995] uses a cylindrical mouse sliding along and rotating about a cylindrical stationary shaft. This type of pointing devices is similar in operation to the mouse with a scroll wheel and hence is not as easy to control the cursor movement by rolling the cylindrical mouse as sliding a mouse. Another constraint similar to the mouse with a scroll wheel is the diameter of the cylindrical mouse needs to be reasonable large for user to roll with fingers and that limits how thin this pointing device can be.

Objects and Advantages

This integrated mouse and pad pointing device functions similar to a conventional mouse with a dedicated pad but comes in a much more compact package and works on almost all surface conditions. Because the mouse slides on a dedicated pad in the integrated mouse and pad pointing device, it moves smoothly and will work perfectly even if the device is placed on a surface that is not smooth such as on the carpet or even it is placed face down on a ceiling.

This integrated mouse and pad pointing device can be made very compact, especially in its height, so it can easily be built into a portable computational device such as a laptop computer or a PDA. Because it operates like a conventional mouse with a dedicated pad, the integrated mouse and pad pointing device offers a much easier and more precise cursor movement control over the touch pad or the pointing stick for the portable computational applications.

In addition, this integrated mouse and pad pointing device may have the click buttons built into the mouse for a convenient one-finger operation of moving the cursor and clicking the buttons at the same time with the same finger that the touch pad or pointing stick does not offer.

As compared to the sliding X-Y table type pointing devices of prior art, this integrated mouse and pad pointing device is relatively simpler and cheaper to make, has a lower profile, is relatively easier to operate, does not stick out from the sides of or stand up above the keyboard if integrated to the keyboard, and has a neater appearance.

When compared to the sliding and rotating cylindrical mouse type pointing device of prior art, this integrated mouse and pad pointing device is relatively simpler and cheaper to manufacture, has a lower profile, is relatively easier to operate, and has a neater appearance.

Further objects and advantages of my invention will become apparent from a consideration of the drawings and ensuing description.

### BRIEF DESCRIPTION OF DRAWINGS

FIG. 1a shows the integrated mouse and pad pointing device as installed in a laptop computer. FIG. 1b shows the integrated mouse and pad pointing device integrated in a keyboard.

FIG. 2a shows the assembly of a preferred embodiment of the integrated mouse and pad pointing device with a linear or Cartesian mouse movement mechanism. FIG. 2b is an exploded view of this preferred embodiment.

FIGS. 3a and 3b show the assembly of another preferred embodiment of the integrated mouse and pad pointing device with a radial mouse movement mechanism and its exploded view, respectively.

FIGS. 4a and 4b show the assembly of a third preferred embodiment of the integrated mouse and pad pointing device also with a Radial mouse movement mechanism and its exploded view, respectively.

FIG. 5a shows the assembly of an embodiment of the integrated mouse and pad pointing device with a radial mouse movement mechanism and two separate and independent mouse movement or position sensing means. FIG. 5b shows the subassembly of the mouse and the pad plate of the integrated mouse and pad pointing device. FIG. 5c shows the pad plate of the device. FIGS. 5d and 5e shows the top and bottom views of the mouse, respectively. FIG. 5f shows the stationary base. FIG. 5g shows an alternate embodiment of the integrated mouse and pad pointing device with a Cartesian mouse movement mechanism and two separate and independent mouse movement or position sensing means.

FIG. 6a shows the assembly of a preferred embodiment of the integrated mouse and pad pointing device with a radial mouse movement mechanism and an optical mouse movement or position sensing means. FIG. 6b shows the top view of the subassembly of the mouse and the pad plate while FIG. 6c shows the bottom view of the pad plate. FIGS. 6d and 6e shows the top and bottom views of the mouse subassembly, respectively. FIG. 6f shows the operating principle of the optical mouse movement sensing means. FIG. 6g shows the stationary base of this embodiment of the integrated mouse and pad pointing device.

FIG. 7a shows the assembly of a preferred embodiment of the integrated mouse and pad pointing device with a radial mouse movement mechanism and a roller ball mechanism as the mouse movement or position sensing means. FIG. 7b shows the bottom view of the subassembly of the mouse and the pad plate while FIG. 7c shows the bottom view of the pad plate. FIGS. 7d and 7e show the top and bottom views of the mouse and the roller ball mechanism. FIG. 7f shows the stationary base of this embodiment.

FIG. 8a shows the assembly of a preferred embodiment of the integrated mouse and pad pointing device with a radial mouse movement mechanism and a magnetic mouse movement sensing unit. FIGS. 8b and 8c show the top and bottom views of the subassembly of the mouse and the pad plate, respectively. FIGS. 8d and 8e show the top and bottom views of the mouse how the magnetic movement sensing unit works with a magnetically conductive layer. FIG. 8f shows the stationary base with a magnetically conductive layer installed on its top surface.

FIG. 9a shows the assembly of a preferred embodiment of the integrated mouse and pad with a radial mouse movement mechanism and a roller ball and a touch pad mouse movement sensing mechanism The mouse assembly is the same as the mouse in the mechanical integrated mouse and pad pointing device with a roller ball in FIGS. 7d and 7e except there is no need for the tracking wheels and the sensors. The stationary base has a touch pad on its top surface that when the mouse moves the attached roller ball rolls on the touch pad and sends a mouse movement signal to the computational device.

### REFERENCE NUMERALS IN DRAWINGS

1 Mouse

2 Pad plate

3 Slot

4 Left click button

5 Right click button

7 Stationary base

8 Housing

10 Mouse/slider unit

11 Slider

12 Recessed fitting

14 Tracking wheel 1

15 Tracking wheel movement sensor

17 Tracking wheel

18 Tracking wheel movement sensor

20 Conducting element

21 Channel

24 Open section

25 Optically transparent section

26 Tongue

27 Rotational mouse movement or position sensing means

28 Linear mouse movement or position sensing means

29 Linear mouse movement or position sensing means

30 Elongated linear position sensing element

31 Roller ball

35 Magnetic sensing means

40 Angular position sensing element

41 Microswitch for left click button

51 Microswitch for right click button

50 Circular conducting element

60 Conducting element

61 Optical movement sensing unit

63 Light source

64 Light beam

65 Collecting lens

66 Image processing unit

70 Elongated linear position sensing element

71 Magnetically conductive layer

73 Touch pad

74 Top surface of the stationary base

76 Groove

### SUMMARY OF THE INVENTION

An integrated mouse and pad pointing device can replace the touch pad or the pointing stick for the portable computational applications such as a laptop computer or a PDA and the conventional mouse for the desktop computational applications such as a desktop computer.

For the portable computational applications this integrated mouse and pad pointing device is a thin and compact component for the package. It is easier to use and can control the cursor movement more accurately than the touch pad or the pointing stick found in most laptop computers. For desktop computational applications, this integrated mouse and pad pointing device can be made as a plug-in device replacing the conventional mouse and will work on any surface such as on the carpet or even if it is placed face down on the ceiling.

With the click buttons integrated to the mouse, the integrated mouse and pad pointing device offers the convenience of one-finger operation of precise control of the movement of the cursor and clicking of the click buttons that the touch pad or pointing stick does not offer.

### DETAIL DESCRIPTIONS OF THE INVENTION

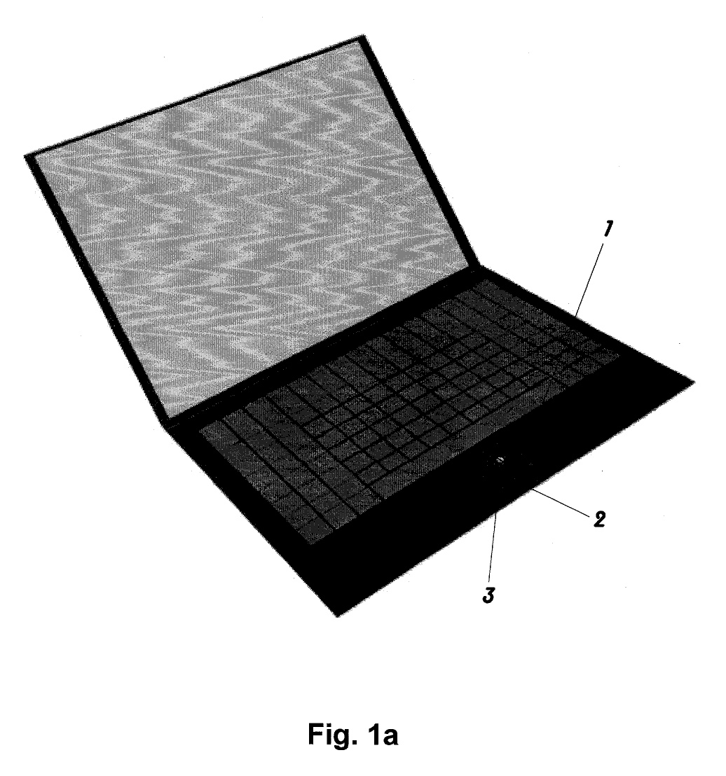

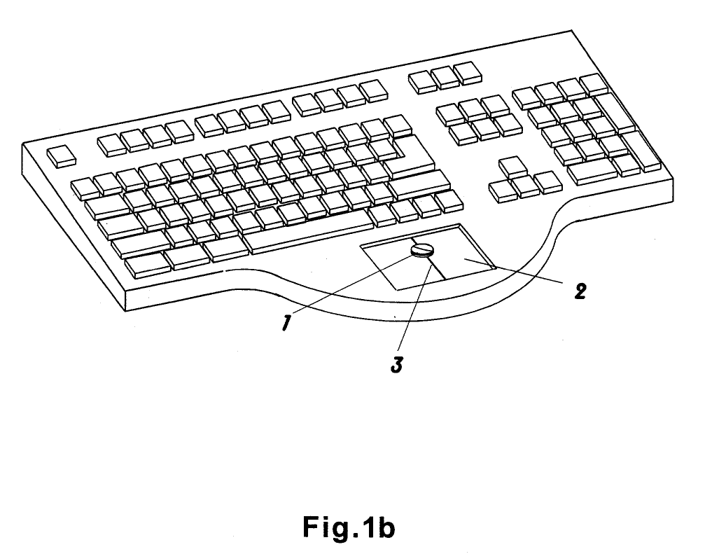

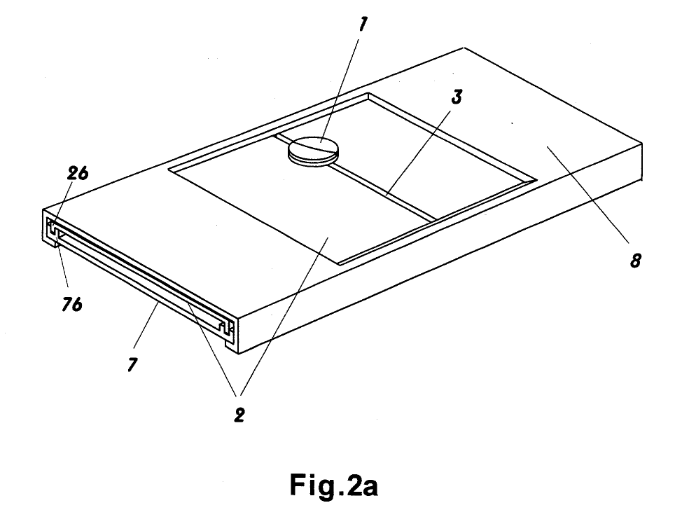

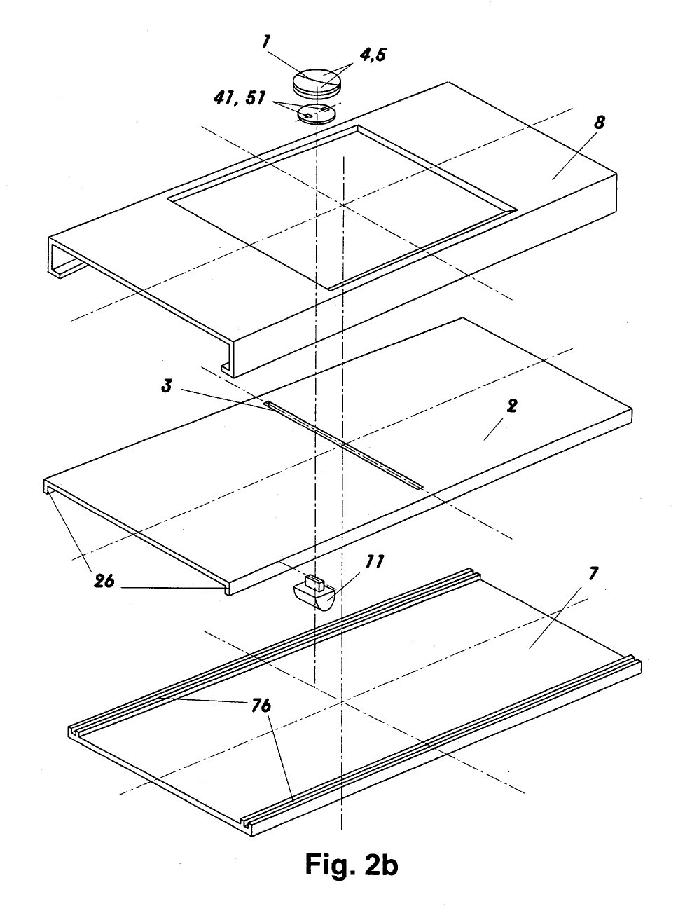

This integrated mouse and pad pointing device can be built into a computational device such as a laptop computer, as shown in FIG. 1a, integrated into a keyboard, as shown in FIG. 1b, or made as a stand-alone device, as shown in FIGS. 2a, 3a, and 4a, that can be plugged into a desktop or laptop computer.

The embodiment of this invention is described in two parts. The first part describes the embodiment of the mouse movement mechanism of the integrated mouse and pad pointing device while the second part describes the embodiment of the mouse movement or position sensing means of the integrated mouse and pad pointing device. The embodiments of the mouse movement mechanism are independent of and compatible with the embodiments of the mouse movement or position sensing means.

1. Embodiment of the Mouse Movement Mechanism

The first preferred embodiment of the mouse movement mechanism of the integrated mouse and pad pointing device, as shown in FIG. 2a, has a Cartesian coordinate system type of mouse movement mechanism. An exploded view of this embodiment is shown in FIG. 2b. In this embodiment a mouse 1 with an attached slider 11 form into a mouse/slider unit 10 that slides relative to a pad plate 2 while the pad plate 2 itself slides relative to a stationary base 7 via a tongue 26 of the pad plate 2 sliding linearly in a groove 76 of the stationary base 7. The housing 8 and the stationary base 7 together hold the integrated mouse and pad pointing device as an assembly.

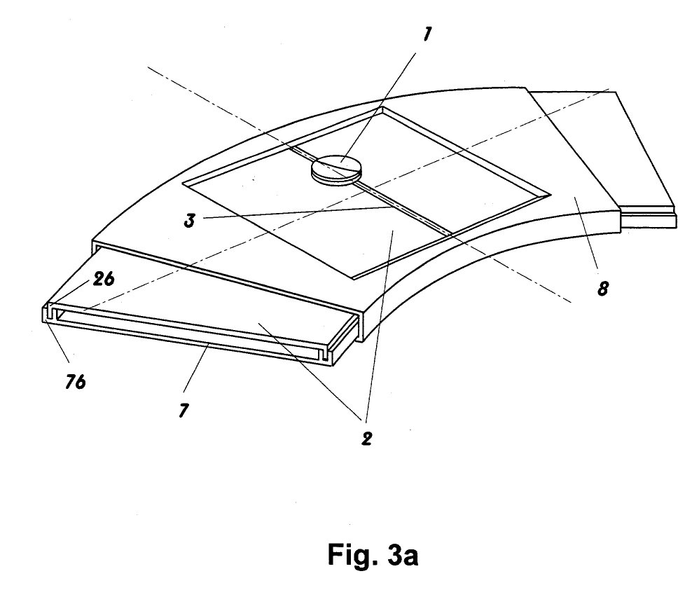

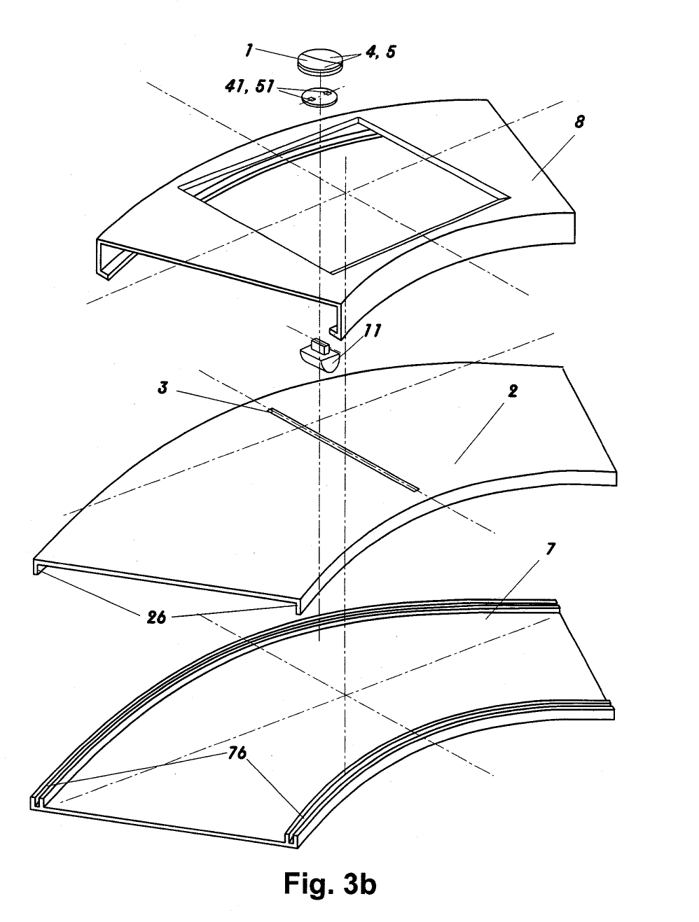

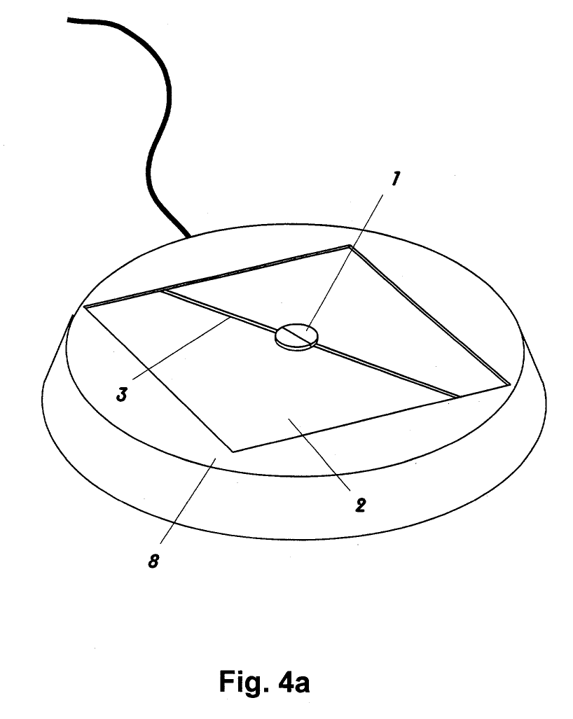

The second preferred embodiment of the mouse movement mechanism of the integrated mouse and pad pointing device, as shown in FIG. 3a, has a Radial coordinate system type of mouse movement mechanism. FIG. 3b shows the exploded view of this embodiment. In this embodiment the mouse 1 with the attached slider 11 also slides in the slot 3 of the pad plate 2 while the pad plate 2 itself rotates pivotally around a stationary base 7 via a tongue 26 of the pad plate 2 sliding pivotally in a groove 76 of the stationary base 7. A mouse movement or position sensing means detects the linear movement or position of the mouse/slider unit 10 relative to the pad plate 2 and the angular movement or position of the pad plate 2 relative to the stationary base 7 and sends a signal to the computational device to determine the movement or position of the cursor on the display accordingly.

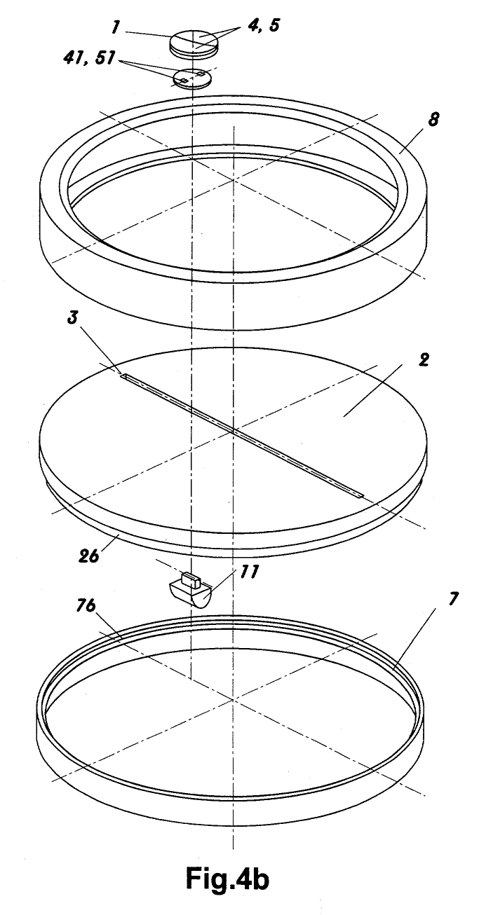

The third preferred embodiment of the mouse movement mechanism of the integrated mouse and pad pointing device, as shown in FIGS. 4a and 4b, also has a Radial coordinate system type of mouse movement mechanism except the pad plate 2 is a circular plate and rotates pivotally around the center of a circular stationary base 7. This embodiment is a special case of the preferred embodiment shown in FIGS. 3a and 3b.

In each of the above cases the mouse/slider unit 10 slides in a slot 3 of the pad plate 2 and also pushes or pulls the pad plate 2 to slide linearly or rotate pivotally relative to the stationary base 7. The movement or position of the mouse 1 is detected by either sensing the movement or position of the mouse 1 relative to the pad plate 2 and the movement or position of the pad plate 2 relative to the stationary base 7 or sensing directly the movement or position of the mouse 1 relative to the stationary base 7.

2. Embodiment of the Mouse Movement or Position Sensing Means

There are two types of embodiments of the mouse movement or position sensing means of the integrated mouse and pad pointing device and they are described below. As mentioned previously, the embodiments of the mouse movement or position sensing means are independent of and compatible with the embodiments of the mouse movement mechanism. So for simplification purpose the Radial-type mouse movement mechanism is used for illustration of the embodiments of the mouse movement or position sensing means below unless described otherwise.

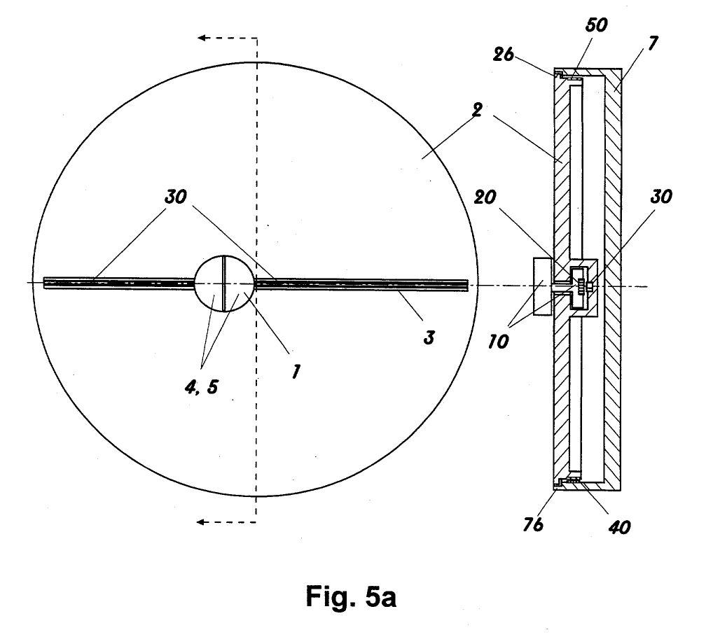

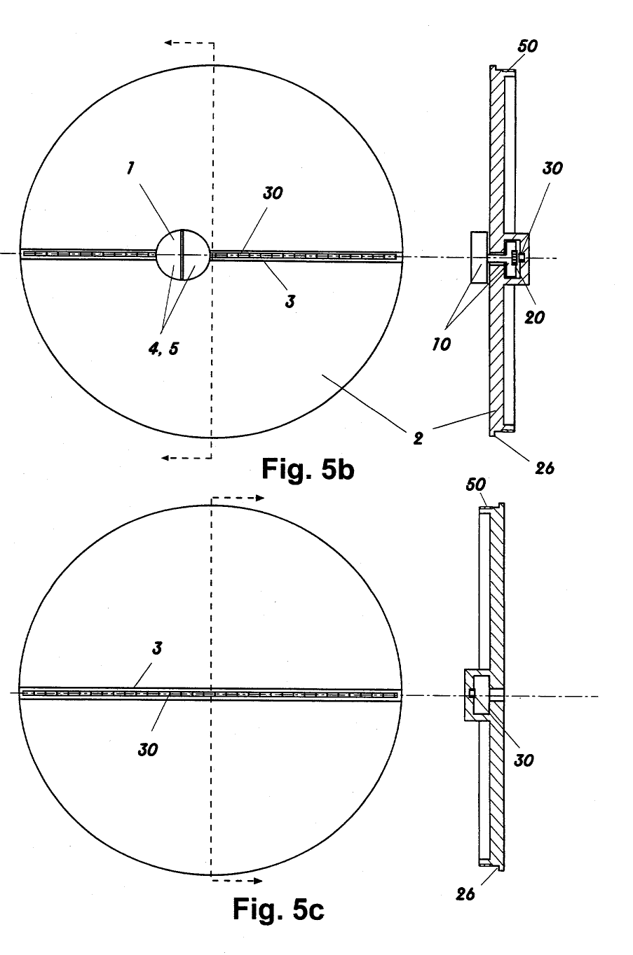

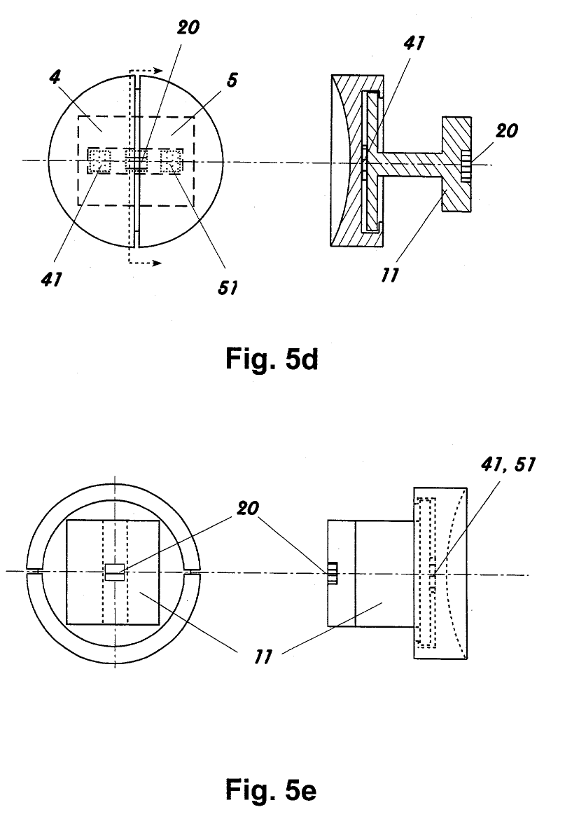

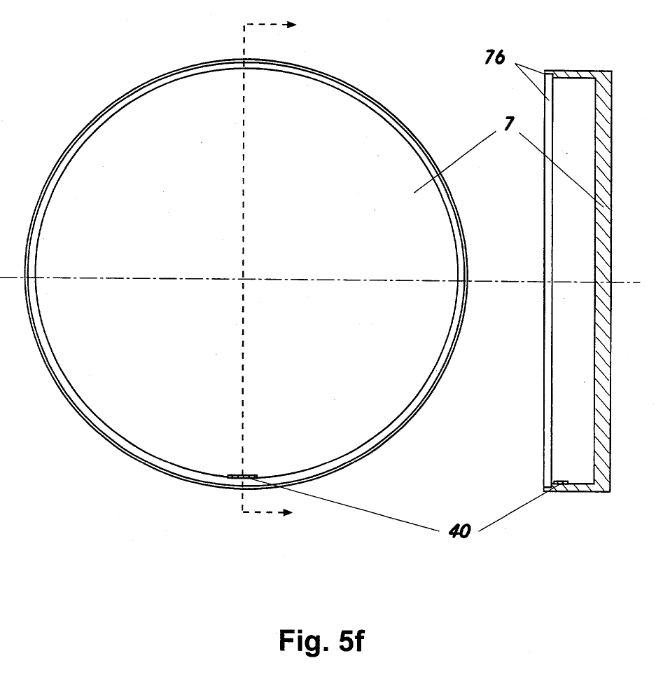

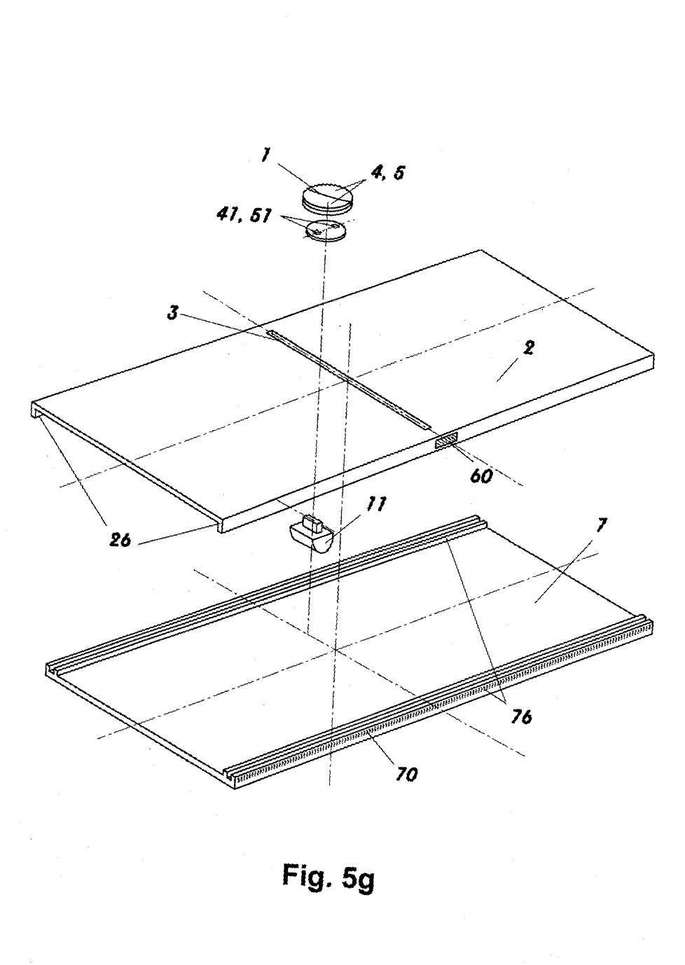

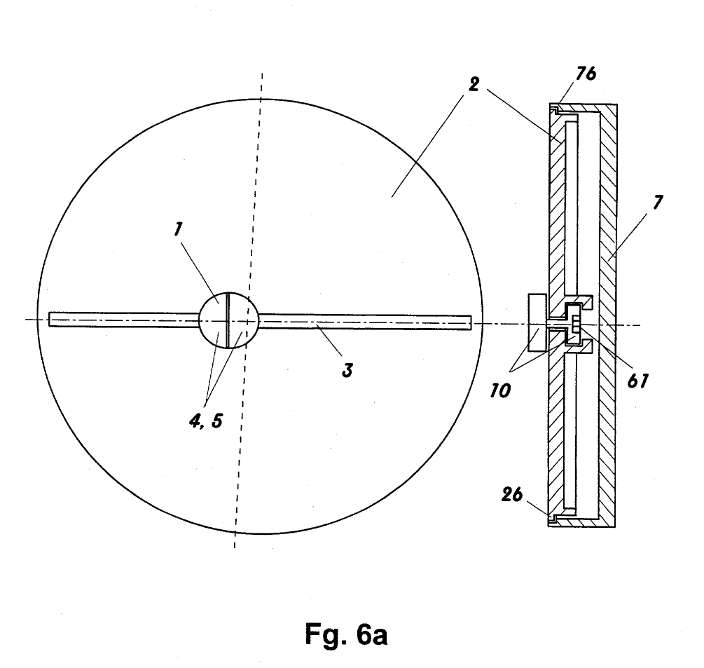

The first type of the preferred embodiments of the mouse movement or position sensing means, as shown in FIGS. 5a-5g, has a set of two separate and independent mouse movement or position sensing means for sensing the movement or position of the mouse relative to the pad plate and the movement or position of the pad plate relative to the stationary base, respectively.

The first embodiment of this type of mouse movement or position sensing means of the integrated mouse and pad pointing device has a linear and an angular mouse movement or position sensing means for the Radial-type mouse movement mechanism. The linear mouse movement or position sensing means for the radial component of the movement or position of the mouse relative to the pad plate is installed between the mouse/slider unit 10 and the pad plate 2, as shown in FIGS. 5a and 5b. It consists of an elongated linear position sensing element 30 installed on the inner side of the bottom of the channel 21 of the pad plate 2 and a matching conducting element 20 attached to the bottom of the slider 11, as shown in FIGS. 5a, 5b, 5c, 5d, and 5e. These two elements together work like a linear electrical variable potentiometer. When the mouse/slider unit 10 slides in the slot 3 of the pad plate 2, the radial component of the mouse movement or position is detected by the interaction between the elongated linear position sensing element 30 and the matching conducting element 20.

The angular mouse movement or position sensing means for the angular component of the movement or position of pad plate relative to the stationary base is installed between the pad plate 2 and the stationary base 7. It consists of a circular conducting element 50 installed on the outside diameter of the pad plate 2 and a matching angular position sensing element 40 attached to the inside diameter of the stationary base 7, as shown in FIGS. 5a, 5b, 5c, and 5f. These two elements together work like a circular electrical variable potentiometer. When the mouse/slider unit 10 pushes or pulls the pad plate 2 to rotate about the stationary base 7, the angular movement or position of the pad plate 2 relative to the stationary base 7 is detected by the interaction between the circular conducting element 50 and the matching angular position sensing element 40.

The elongated linear position sensing element 30 and the angular position sensing element 40 generate and send the signals representing the radial component and the angular component, respectively, of the movement or position of the mouse 1 to the computational device to determine the movement or position of the cursor on the display.

The two click buttons 4 and 5 are integral part of the mouse 1 in this embodiment, as shown in FIGS. 5a, 5b, 5d, and 5e. When pressed the click button 4 or 5 touches a microswitch 41 or 51, respectively, which in turn generates and sends a click signal to the computational device.

A similar embodiment of the mouse movement or position sensing means of the integrated mouse and pad pointing device for the Cartesian-type mouse movement mechanism also has a set of two separate and independent linear mouse movement or position sensing means. The first linear mouse movement or position sensing means, as shown in FIG. 5g, is installed between the mouse/slider unit 10 and the pad plate 2 for detecting the linear movement or position of the mouse 1 relative to the pad plate 2. It also has an elongated linear position sensing element 30 and a matching conducting element 20 like the linear mouse movement or position sensing means for the Radial-type mouse movement mechanism shown in FIG. 5a.

The second linear mouse movement or position sensing means of the integrated mouse and pad pointing device for the Cartesian-type mouse movement mechanism is installed between the pad plate 2 and the stationary base 7 for detecting the linear movement or position of the pad plate 2 relative to the stationary base 7. It consists of an elongated linear position sensing element 70 installed on the stationary groove 76 of the stationary base 7 and a matching conducting element 60 on a matching tongue 26 of the pad plate 2. These two elements together also work like a linear electrical variable potentiometer. When the mouse/slider unit 10 pushes or pulls the pad plate 2 to slide relative to the stationary base 7, the linear movement or position of the pad plate 2 relative to the stationary base 7 is detected by the interaction between the elongated linear position sensing element 70 and the matching conducting element 60.

The second type of preferred embodiments of the mouse movement or position sensing means of the integrated mouse and pad pointing device has a set of mouse movement or position sensing means installed between the mouse/slider unit 10 and the stationary base 7 that directly detects the movement or position of the mouse relative to the stationary base.

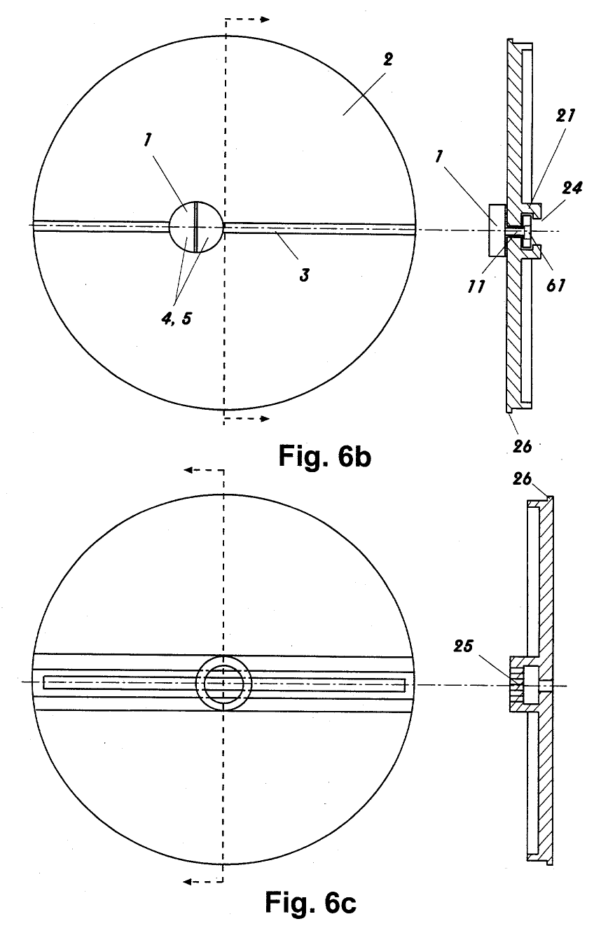

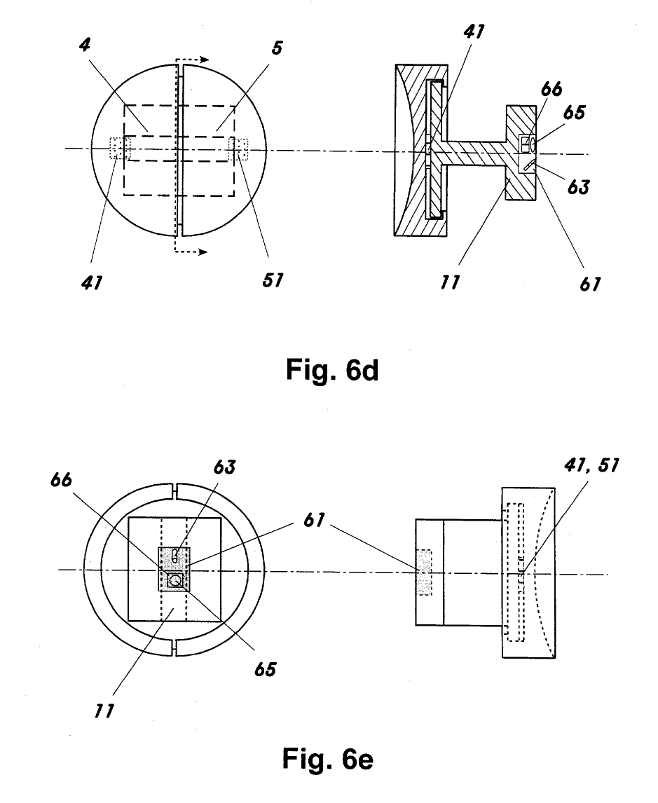

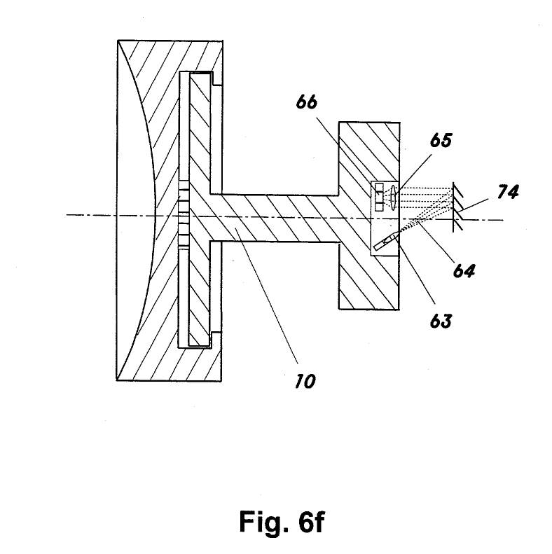

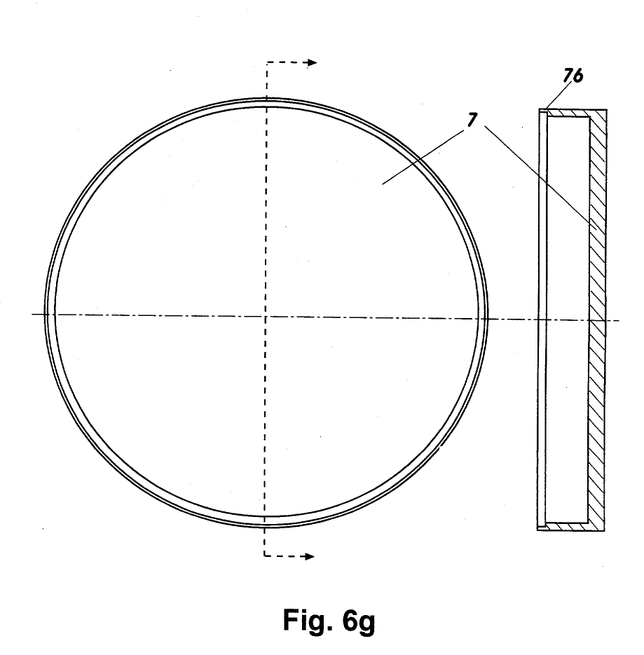

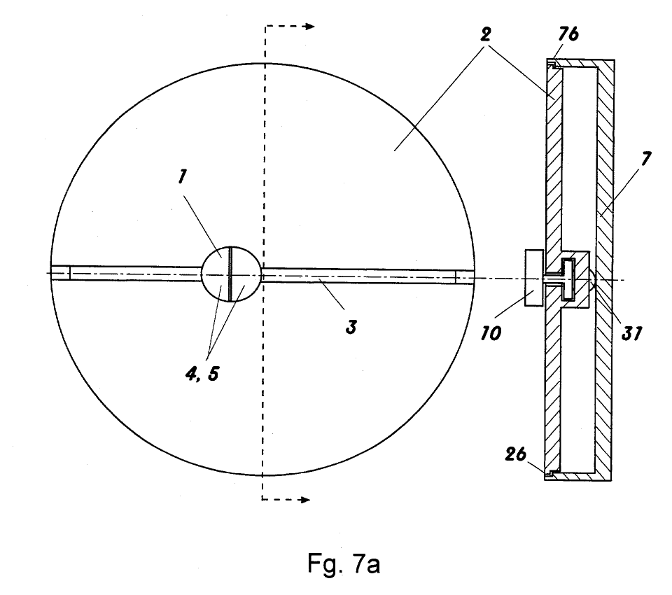

One preferred embodiment of this type of mouse movement or position sensing means of the integrated mouse and pad pointing device is an optical movement sensing unit 61, as shown in FIG. 6a. This optical mouse movement or position sensing unit is installed at the bottom of the mouse/slider unit 10, as shown in FIGS. 6a and 6b. With a predetermined distance between the optical movement sensing unit 61 and the top surface the stationary base 7, the optical movement sensing unit 61 takes quick sequential shots of the top surface of the stationary base 7 through an open section 24, as shown in FIG. 6b, or an optically transparent section 25, as shown in FIG. 6c, at the bottom of the channel 21 while the mouse/slider unit 10 moves. An image processing unit 66, as shown in FIG. 6d, compares the images of the quick sequential shots to determine the movement of the mouse 1 relative to the stationary base 7 and sends a signal to the computational device to move the cursor on the display accordingly.

FIGS. 6d and 6e show the components in the optical movement or position sensing unit and FIG. 6f shows the working principle of the optical mouse movement or position sensing means. A light source 63, such as a LED (light emitting diode), shoots a light beam 64 to the top surface of the stationary base 7. Part of the light beam 64 is reflected from the top surface of the stationary base 7 back through a collecting lens 65 to an optical image processing unit 66 (such as a video camera's image chip) to form an image. The optical image processing unit 66 processes the image of the top surface of the stationary base 7 and compare it to the previously 15 images of the top surface of the stationary base 7 to determine the direction and rate of movement of the mouse/slider unit 10 relative to the stationary base 7. To make the comparison of images easier and more effective, the top surface of the stationary base 7 can be marked with grid lines or other optical identification-enhancement textures. FIG. 6g shows the stationary base 7.

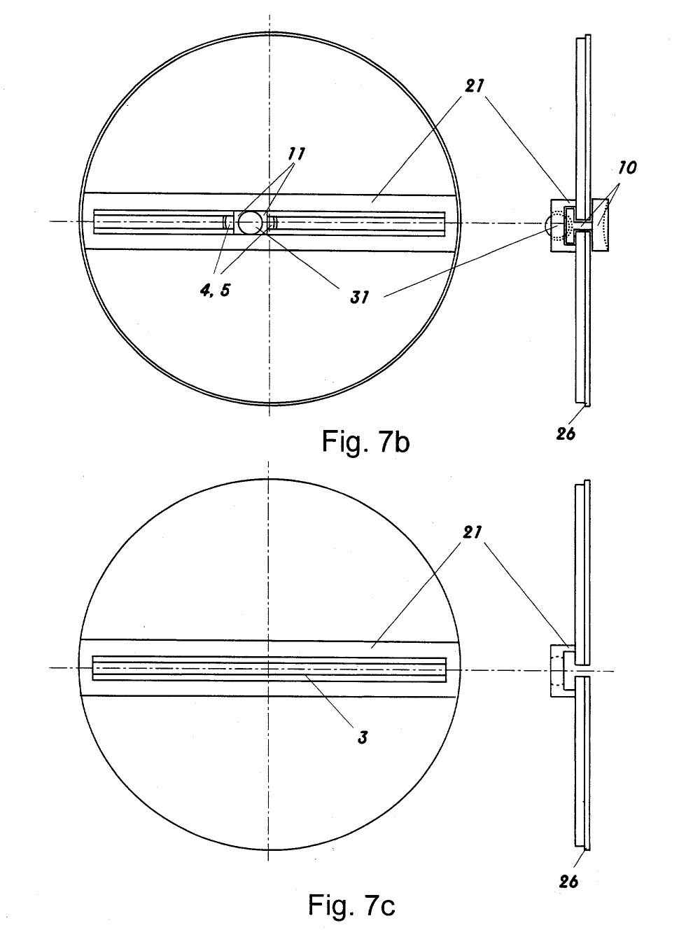

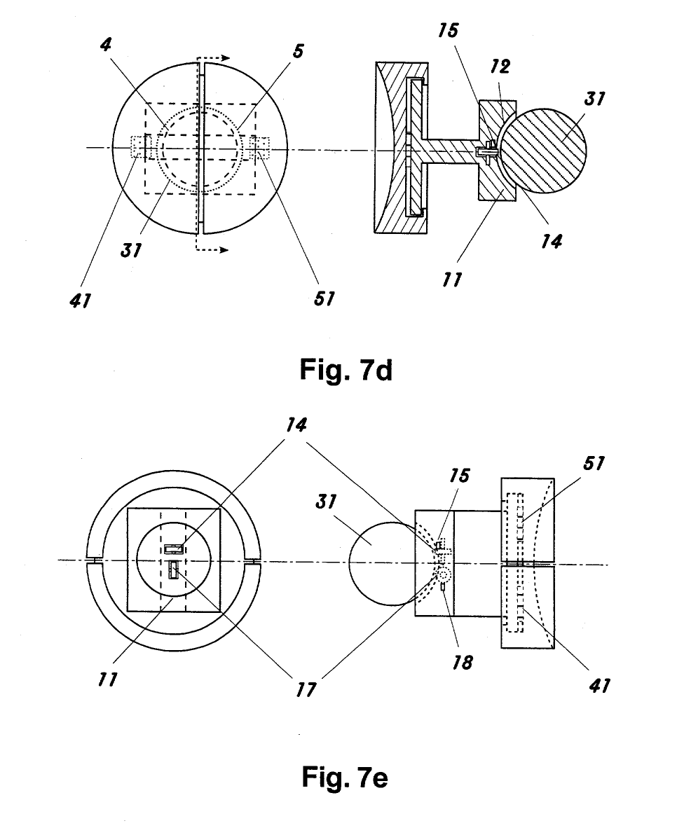

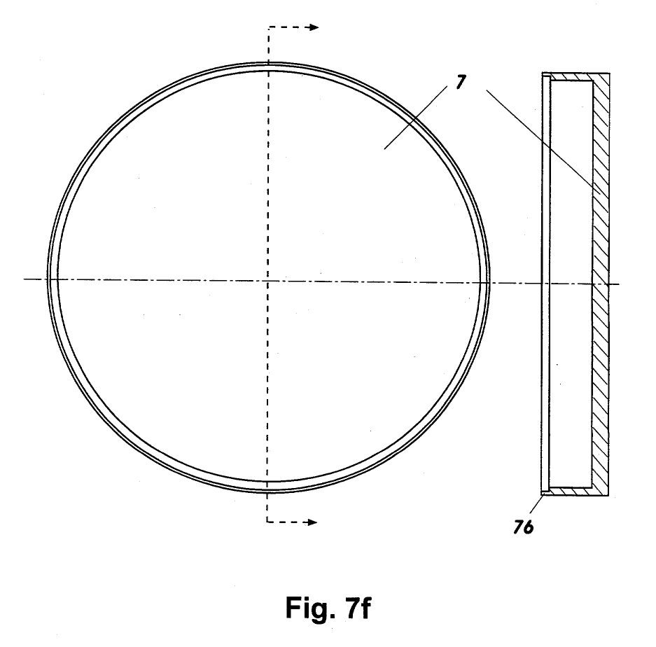

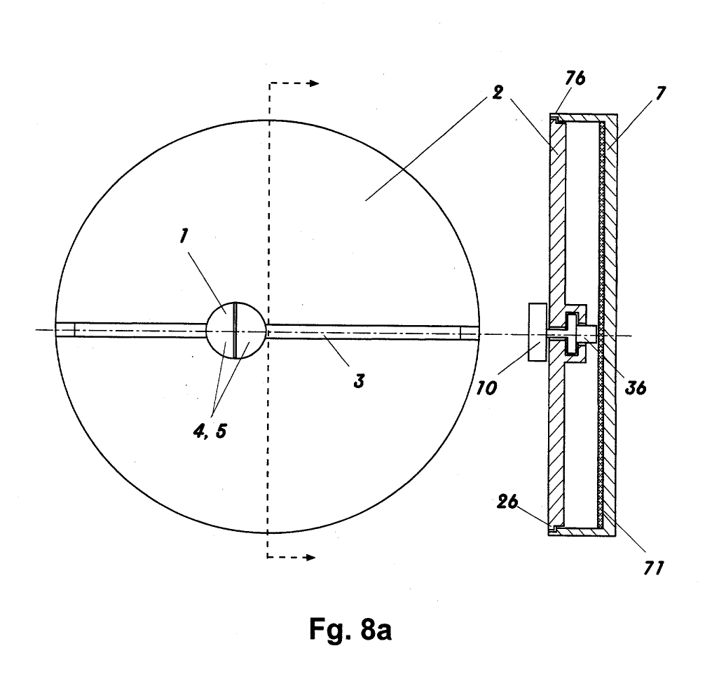

Another preferred embodiment of the mouse movement or position sensing means of the integrated mouse and pad pointing device installed in the mouse/slider unit has a roller ball mechanism. When the mouse 1 moves the roller ball 31 follows and rolls on the stationary base plate 7, as shown in FIG. 7a. The slider 11 has a recessed fitting 12 at its bottom, as shown in FIGS. 7b, 7d, and 7e, that holds the roller ball 31 and allows it roll on the stationary base 7 to follow the movement of the mouse/slider unit 10. The roller ball 31, when it rolls, drives two tracking wheels 14 and 17, as shown in FIGS. 7d and 7e. A tracking wheel movement sensor 15 detects the rotational movement of the tracking wheel 14 and another tracking wheel movement sensor 18 detects the rotational movement of the track wheel 17 to determine the movement of the mouse/slider unit 10 relative to the stationary base 7. FIG. 7f shows the stationary base 7.

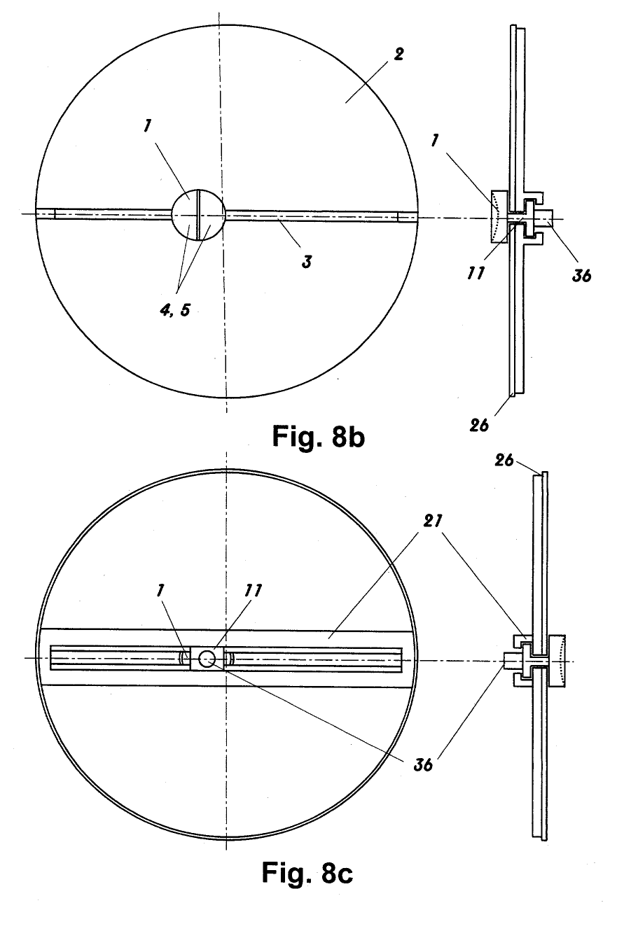

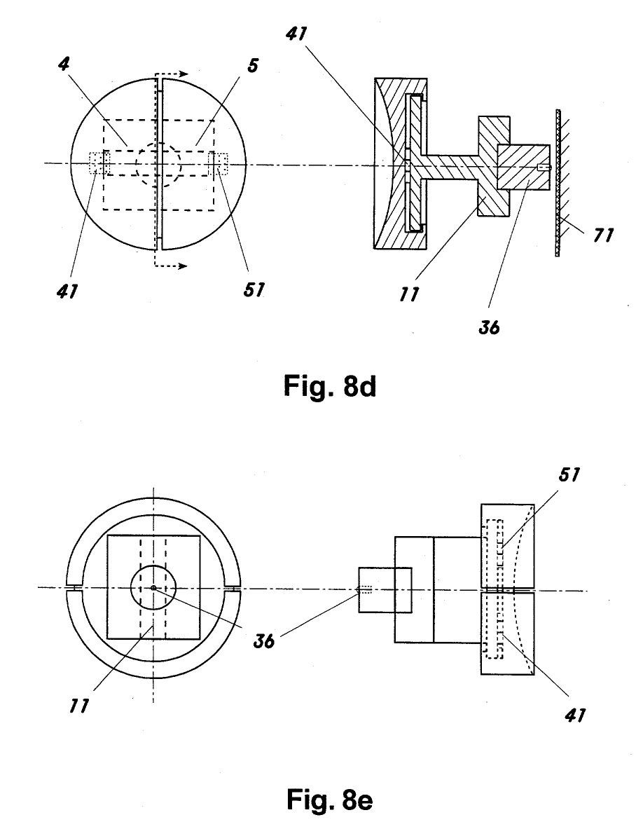

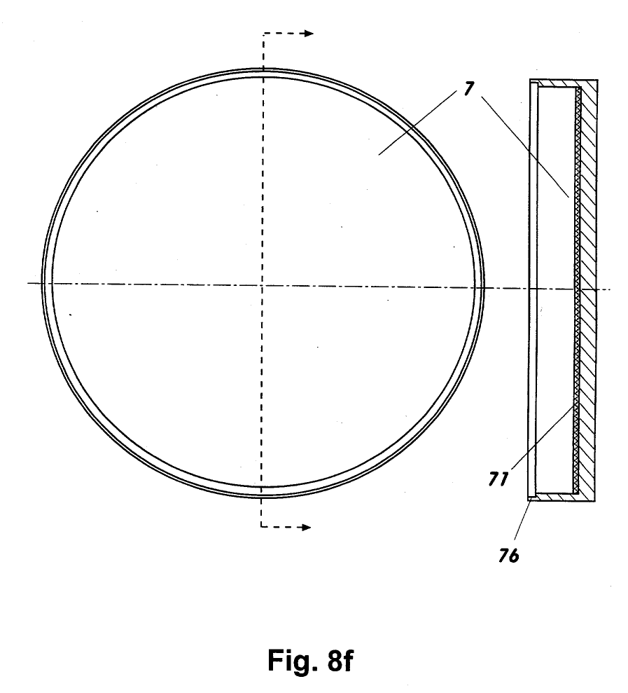

An alternate embodiment of the mouse movement or position sensing means of the integrated mouse and pad pointing device has a magnetic movement sensing unit. The slider 11 has a magnetic movement sensing unit 36 attached to its bottom, as shown in FIGS. 8a, 8b, and 8c. When the mouse/slider unit 10 slides in the slot 3 of the pad plate 2 it carries the magnetic movement sensing unit 36 across the stationary base 7 which has a magnetically conductive layer 71 on its top surface, as shown in FIGS. 8a, 8d, 8e, and 8f. The magnetic movement sensing unit 36 interacts with the magnetically conductive layer 71, as shown in FIG. 8d, to detect the movement of the mouse 1 relative to the stationary base 7 and generate a mouse movement signal.

The magnetically conductive layer 71, as shown in FIG. 8d, has a property of varying magnetic conductivity across the layer. When the magnetic sensing means 36 moves across the magnetically conductive layer 71 it picks up a magnetic signal of varying strength that can be used to identify in which direction and at what rate the mouse is moving.

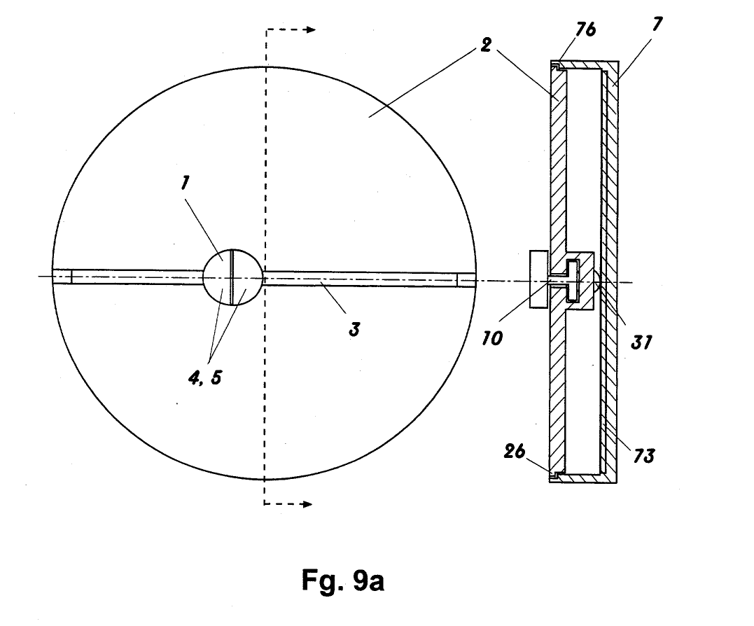

Another alternate embodiment of the mouse movement or position sensing means of the integrated mouse and pad pointing device has a roller ball attached to the mouse/slider unit and a touch pad on the top surface of the stationary base, as shown in FIG. 9a. The mouse/slider unit 10 with the roller ball 31 is basically the same as the design in FIGS. 7d and 7e except it has no tracking wheels and sensors. The stationary base 7 is similar to the design in FIG. 7f except there is a touch pad 73 on the top surface of the stationary base 7. When the mouse/slider unit 10 moves the roller ball 31 rolls on the touch pad 73 and the touch pad 73 sends a mouse movement or position signal to the computational device to control the movement of the cursor on the display.

### CONCLUSION, RAMIFICATIONS, AND SCOPE

Thus the reader will see that the integrated mouse and pad pointing device of the invention provides a self-contained mouse and pad system that functions like a conventional mouse with a dedicated pad and can be made very thin and compact to fit in a laptop computer, a PDA, or a cell phone, or it can be made as a standalone device that works on any type of surfaces.

While my above description contains many specificities, these should not be construed as limitations on the scope of the invention, but rather as an exemplification of some preferred embodiments thereof. Many other variations are possible. For example, the mouse movement or position sensing means for detecting the movement or position of the mouse relative to the pad plate shown in FIGS. 5a-5h can be embodied with either a linear electrical variable potentiometer with an electrical conducting element attached to the mouse and an elongated electrical resistor element attached to the pad plate or a magnetic sensing means with a magnetically conducting element attached to the mouse and a magnetic sensing element attached to the pad plate.

I claim:

1. An integrated mouse and pad pointing device for cursor control in a display means of a computational device comprising:
(a). A stationary base.
(b). A pad plate with a straight or curvilinear slot.
(c). A sliding means that allows said pad plate slides relative to said stationary base.
(d). A pad plate holding means that prevents said pad plate from separating from said stationary base when said pad plate slides relative to said stationary base.
(e). A mouse.
(f). A sliding means that allows said mouse slides in said slot of said pad plate
(g). A set of movement or position sensing means that detects the movement or position of said mouse relative to said stationary base and generates and sends a signal of the movement or position of said mouse relative to said stationary base to a mouse movement or position computing means.
(h). Said mouse movement or position computational means computes and determines the movement or the position of said cursor in said display means of said computational device from said signal of the movement or position of said mouse relative to said stationary base.

2. An integrated mouse and pad pointing device for cursor control in a display means of a computational device, as stated in claim 1, further including
(a). One or a plurality of click buttons that are installed on said mouse
(b). An on-off switch means attached to said mouse under each of said click buttons that sends a signal to said computational device to signal the clicking of said click button when said click button over said on-off switch means is clicked or pressed whereby the clicking of said buttons may be conveniently executed at the same time as when said mouse is being moved

3. An integrated mouse and pad pointing device for cursor control in a display means of a computational device, as stated in claim 1, wherein
(a). Said movement or position sensing means comprising a mouse-to-pad movement or position sensing means that detects the movement or position of said mouse in said slot of said pad plate relative to said pad plate and a pad-to-base movement or position sensing means that detects the movement or position of said pad plate relative to said stationary base that generate and send a mouse-to-pad movement or position signal of said movement or position of said mouse in said slot of said pad plate relative to said pad plate and a pad-to-base movement or position signal of said movement or position of said pad plate relative to said stationary base, respectively, to said mouse movement or position computing means whereby the movement or position of said cursor on said display means of said computational device is determined by a combination of said mouse-to-pad movement or position signal and said movement or position signal of said pad-to-base movement or position signal.

4. An Integrated mouse and pad pointing device for cursor control in a display means of a computational device, as stated in claim 3, further including
(a). One or a plurality of click buttons that are installed on top of said mouse
(b). An on-off switch means attached to said mouse under each of said click buttons that sends a signal to said computational device to signal the clicking of said click button when said click button over said on-off switch means is clicked or pressed whereby the clicking of said click buttons may be conveniently executed at the same time as when said mouse is being moved.

5. An integrated mouse and pad pointing device for cursor control in a display means of a computational device, as stated in claim 1, wherein
(a). Said movement or position sensing means comprising a movement or position sensing means that detects the position or movement of said mouse in said slot of said pad plate relative to said stationary base that generates and sends a mouse movement or position signal to said mouse movement or position computing means whereby the movement or position of said cursor on said display means of said computational device is determined by said mouse movement or position signal

6. An Integrated mouse and pad pointing device for cursor control in a display means of a computational device, as stated in claim 5, further including
(a). One or a plurality of click buttons that are installed on top of said mouse
(b). An on-off switch means attached to said mouse under each of said click buttons that sends a signal to said computational device to signal the clicking of said click button when said click button over said on-off switch means is clicked whereby the clicking of said click buttons may be conveniently executed at the same time as when said mouse is being moved.

7. An integrated mouse and pad pointing device for cursor control in a display means of a computational device comprising:
(a). A stationary base
(b). A pad plate with a straight or curvilinear slot
(c). A rotational means that allows said pad plate moves pivotally about said stationary base
(d). A pad plate holding means that prevents said pad plate from separating from said stationary base when said pad plate slides relative to said stationary base
(e). A mouse
(f). A sliding means that allows said mouse slides in said slot of said pad plate
(g). A set of movement or position sensing means that detects the position or movement of said mouse and generates and sends a signal of the movement or position of said mouse to said computational device to a mouse movement or position computing means.
(h). Said mouse movement or position computational means computes and determines the movement or the position of said cursor in said display means of said computational device from said signal of the movement or position of said mouse relative to said stationary base.

8. An integrated mouse and pad pointing device for cursor control in a display means of a computational device, as stated in claim 7, further including
(a). One or a plurality of click buttons that are installed on top of said mouse
(b). An on-off switch means attached to said mouse under each of said click buttons that sends a signal to said computational device to signal the clicking of said click button when said click button over said on-off switch means is clicked whereby the clicking of said click buttons may be conveniently executed at the same time as said mouse is being moved

9. An integrated mouse and pad pointing device for cursor control in a display means of a computational device, as stated in claim 7, wherein
(a). Said movement or position sensing means comprising a mouse-to-pad movement or position sensing means that detects the movement or position of said mouse in said slot of said pad plate relative to said pad plate and a rotational pad-to-base movement or position sensing means that detects the rotational movement or position of said pad plate pivotally relative to said stationary base that generate and send a mouse-to-pad movement or position signal of said movement or position of said mouse in said slot of said pad plate relative to said pad plate and a rotational pad-to-base movement or position signal of said rotational movement or position of said pad plate pivotally relative to said stationary base, respectively, to said mouse movement or position computing means device whereby the movement or position of said cursor on said display means of said computational device is determined by a combination of said mouse-to-pad movement or position signal and said rotational pad-to-base movement or position signal

10. An Integrated mouse and pad pointing device for cursor control in a display means of a computational device, as stated in claim 9, further including
(a). One or a plurality of click buttons that are installed on top of said mouse
(b). An on-off switch means attached to said mouse under each of said click buttons that sends a signal to said computational device to signal the clicking of said click button when said click button over said on-off switch means is clicked or pressed whereby the clicking of said click buttons may be conveniently executed at the same time as when said mouse is being moved

11. An integrated mouse and pad pointing device for cursor control in a display means of a computational device, as stated in claim 7, wherein
(a). Said movement or position sensing means comprising a movement or position sensing means that detects the movement or position of said mouse in said slot of said pad plate relative to said stationary base that generates and sends a mouse movement or position signal to said mouse movement or position computing means whereby the movement or position of said cursor on said display means of said computational device is determined by said mouse movement or position signal

12. An Integrated mouse and pad pointing device for cursor control in a display means of a computational device, as stated in claim 11, further including
(a). One or a plurality of click buttons that are installed on top of said mouse.
(b). An on-off switch means attached to said mouse under each of said click buttons that sends a signal to said computational device to signal the clicking of said click button when said click button over said on-off switch means is clicked whereby the clicking of said click buttons may be conveniently executed at the same time as when said mouse is being moved.

13. A cursor control method for a computational device with a display means comprising steps of
(a). Sliding a mouse in a slot of a pad plate and dragging said mouse against said pad plate to slide relative to a stationary base whereby the movement or position of said mouse covers a predetermined area corresponding to the display area of said display means of said computational device.
(b). Detecting the movement or position of said mouse in said predetermined area by a set of movement or position sensing means and sending a signal of the movement or position of said mouse to said computational device for determining the movement or position of said cursor in the display area of said display means of said computational device.

14. A cursor control method for a computational device with a display means comprising steps of
(a). Sliding a mouse in a slot of a pad plate and dragging said mouse against said pad plate to move pivotally about a stationary base plate whereby the movement or position of said mouse covers a predetermined area corresponding to the display area of said display means of said electronic computational device
(b). Detecting the movement or position of said mouse in said predetermined area by a set of movement or position sensing means and sending a signal of the movement or position of said mouse to said computational device for determining the movement or position of said cursor in the display area of said display means of said computational device
